(19) United States
(12) Patent Application Publication
(10) Pub. No.: US 2011/0009202 A1
(43) Pub. Date: Jan. 13, 2011

(54) TOY BOWLING

(76) Inventor: Frank J. Grasso, Cleveland, OH (US)

Correspondence Address: Frank J. Grasso, 16001 Euclid Beach Blvd., 816, Cleveland, OH, 44110, US

(21) Appl. No.: 12/818,447

(22) Filed: Jun. 18, 2010

Related U.S. Application Data
(63) Continuation of application No. 61/270,519, filed on Jul. 9, 2009.

(51) Int. Cl. A63D 1/02; A63D 9/00; G09B 19/00

(52) U.S. Cl. 473/116; 473/118; 434/207

(57) ABSTRACT

A toy educational bowling game for toddlers with a toy bowling ball, a plurality of toy bowling pins which are marked with a separate and individual number in numerical order starting with the number one and a pin set up guide whereupon there are a plurality of markings for the placement of the pins and each of the markings has a separate and individual number arranged in numerical order starting with the number one and in the similar numerical alignment as when conventional bowling pins are lined up for the beginning of play of conventional bowling whereby a toddler can learn numbers and counting by matching the numbered pins to the numbered markings in numerical order on the pin set up guide. Variations include various further features including indentations, matching colors, shapes, letters, with the locations being in front of the markings and with audio and lighting systems.

### CROSS-REFERENCE TO RELATED APPLICATIONS

This applicant claims the benefit of provisional patent application Ser. No. 61/270,519 filed 2009 Jul. 9 by the present inventor.

### FEDERAL SPONSORED RESEARCH Not Applicable

### SEQUENCE LISTING OR PROGRAM Not Applicable

### BACKGROUND

1. Field of Invention

This invention relates to an educational toy bowling game for toddlers. This is an apparatus relating to the type of amusement, recreational, or play activities commonly known as games or sports. This is also is an apparatus used as a tool for the learning

### BACKGROUND

2. Prior Art

There are toy bowling games for toddlers however none have specific features of the present invention that can be used to teach a toddler numbers and counting. Various versions of the invention include further features using audio, lights, colors, shapes and letters as elements for tools to teach toddlers numbers, counting, shapes, colors and letters which previous toy bowling games for toddlers lack.

### BRIEF SUMMARY OF THE INVENTION

The object of the invention is to teach toddlers numbers and to count while having fun bowling. In various embodiments of the invention other objects include teaching toddlers colors, and/or shapes, and/or letters. In other embodiments of the invention an object is to facilitate the placement of the pins on the pin set up guide by having indentations on the set up guide so a toddler can easily place the pins.

In all of the embodiment of the invention except if noted otherwise there is a toy bowling ball, toy bowling pins and a pin set up guide for the placement of the pins and each of the pins have a separate and individual number that matches to numbered markings on the pin set up guide and the numbered marking are a arranged in numerical order and in the similar numerical alignment as when conventional bowling pins are lined up for the beginning of play of a conventional bowling whereby a toddler can learn numbers and to count from by matching the numbered pins in numerical order to the numbered markings on the pin set up guide.

In other embodiments of the invention each of the markings on the pin set up guide is marked with a different color that matches to one of each of the pins with the same color whereby a toddler can learn to different colors by matching the color pins to the color markings.

In other embodiments of the invention the numbers on the pin set up guide are in front of the markings whereby after a toddler matches the pins to the numbered markings, the numbers of the markings are still visible whereby visually reinforcing the learning of the numbers and counting

In other embodiments of the invention each marking on the pin set up guide has a different shape that matches to one of each of the pins with the same shape whereby a toddler can learn different shapes by matching the pins with different shapes to the markings with the same shape.

In other embodiments of the invention each of the markings on the pin set up guide has a different letter that matches to one of each of the pins marked with same letter whereby a toddler can learn different letters by matching the pins marked with letters to the markings with the same letter.

In other embodiments of the invention there is an audio system which responds with phrases of instructions and reinforcement for the matching the numbered pins to the numbered markings in numerical order whereby a toddler can be verbally instructed to count from by matching the numbered pins in numerical order to the numbered markings.

In other embodiments of the invention there is an audio system with two or three modes which include number mode, color mode and/or shape mode which responds with phrases of instructions and reinforcement for the matching of the pins with different numbers and/or colors and/or shapes to the markings with numbers and/or colors and/or shapes according to the respective mode.

In other embodiments of the invention there is a lighting system which responds to provide visual reinforcement for the learning of numbers and counting so when a correct match of the numbered pins to the number markings in numerical order is made, a green light is turned on and when a when a match of the numbered pins to the number markings out of numerical order is made a yellow light is turned on and when an incorrect matched is made a red light is turned on or no light is turned on, and the like.

In other embodiments of the invention there is a lighting system with two or three modes which include number mode, color mode and/or shape mode and when in number mode responds with a green light for a correct match in numerical order and when a match is out of numerical order is made a yellow light is turned on, and for an incorrect match no light or a red light is turn on and when in color mode or shape mode when a correct match is made a green light is turned on and when an incorrect match is made no light or a red light is turn on, and the like.

In other embodiments of the invention there is a lighting system and an audio system with different modes to provide for the visual and oral reinforcement for the learning of numbers, counting and/or colors and/or shapes and/or letters according to the respective mode.

In other embodiments of the invention there is a lighting system that can display on the pins and markings according to the mode chosen numbers or colors or shapes or letters that responds with further lights with green for correct matches, no light or a red light for incorrect matches and when in number mode a yellow light for matches made out of numerical order, and the like and there is a audio system with different modes which responds with phrases of instruction and reinforcement according to the mode chosen.

### DETAILED DESCRIPTION OF THE INVENTION

The invention relates to a toy educational bowling game for toddlers, which assist toddlers in learning to count and/or coordination skills and/or social skills and/or learning different colors and/or shapes and/or letters of the alphabet.

The first embodiment of the present invention comprises ten toy bowling pins and each of the ten pins are marked with a separate and different individual number from a set often numbers from one to ten, and the first embodiment of the invention further comprises a base preferably in the forth or shape same as or similar to a rectangle or triangle, though it is understood other shapes are acceptable and the bottom surface of the base is to be placed on a supporting surface such as a floor and/the top surface of said base forms a bowling pin deck with a pin set up guide whereupon here are ten markings which markings can be of various designs with the preferable design being in the form of a circle or similar to a circle and where said markings are hereinafter are referred to as circles except as otherwise noted and/or referred as. The circles are formed into rows similar and/or comparable to and/or the same as the shape and/or alignment formed when conventional bowling pins are lined up for the beginning of play of a conventional bowling and/or the outer circles form the same shape or similar shape of a triangle and each circle is marked in its vicinity or less preferably within the circle itself with a separate and different individual number from the same set of numbers from one to ten in numerical order and preferably each number is below and/or in front of each circle and whereby preferably below the first circle which forms the first row of circles is marked with the number one and two circles form the second row of circles and below the circle on the far left of the second row is marked with the number two and below the next circle of the second row is marked with the number three and three circles form the third row of circles and below the circle on the far left of the third row is marked with the number four and below the next circle to the right of the third row is marked with the number five and below the last circle of the third row is marked with the number six and four circles form the fourth row of circles and below the first circle to the far left of the fourth row is marked with the number seven and below the next circle to the right of the fourth row is marked the number eight and below the next circle to the right of the fourth row is masked with the number nine and below the last circle of the fourth row is marked with the number ten, and whereby preferably in the vicinity of each circle and more preferably below and/or in front of each circle is an individual and different number from the same set of numbers from one to ten in numerical order and the circles' corresponding numbers are arranged in the same numerical alignment as when conventional bowling pins are lined up for the beginning of play of a conventional bowling. The first embodiment of the invention further comprises a toy bowling ball preferably with two finger holes and a thumb hole and said ball may have as preferred be provided with a different or same, color or color scheme, and/or marked with numbers and/or a number including zero and/or different shapes and/or patterns and/or characters such as animals and/or cartoon characters and/or maybe made of translucent and/or transparent material such as translucent and/or transparent plastic.

Each circle is preferably the same or the similar size as the bottom of a toy pin though it is understood that the circles may be of other sizes within reasonably parameters as preferred. Each circle may be indented within the base as preferred, so as to make the placement of the pins unto the circles easier for the toddler. In the first embodiment of the invention the base's preferred height is less than ¼ of an inch, and more preferably the base's height is less than ⅛ of an inch, however it is understood other heights are acceptable so long the base can be placed flat on a ground surface such as a floor, whereby the small bowling ball, can roll on to it so as to hit the pins, without undue difficulty and if preferred high enough for the indentations of the circles. The area of the base is preferably large enough to mark the pin deck upon it as described herein and preferably small enough so as not to be excessively bulky and/or cumbersome to maneuver for its placement. The base may also have as preferred two adjustable guide walls, each of which can be placed and/or connected to the opposite sides of the base at the front of the base.

Unless otherwise indicated herein, the major component elements of the present invention are preferably molded or otherwise fabricated from a child safe, lightweight preferably polymer material (plastic) and/or a soft foam rubber, and/or hollow vinyl. However, it is to be understood that other materials, may be used which substantially have similarly effectiveness. However, the base in the first embodiment of the invention may preferably be made of cloth, plastic or similar child safe material. The elements of the present invention are preferably fabricated in accordance with conventional fabrication techniques. The scope of the present invention is not intended to be limited by the recitation of any particular type of preferred material for any particular component part, and/or preferred design, components, features, elements, operations, structures, constructions, game play and learning scenarios nor by the recitation of any preferred fabrication method.

The toy pins preferably have a body portion fashioned in the similar shape and/or same shape of conventional bowling pins and the toy pins preferably are of a smaller size, and with a preferably lighter weight, and the width may be preferably wider than standard bowling pins so as to facilitate the knocking down of the toy pins by the toddler with the toy ball, however it is understood that the pins of the invention can have other shapes, weights, sizes and widths so long said pins can function as pins appropriate for a toddler. The toy bowling ball preferably is of a small size and of a lighter weight than a standard bowling ball. The toy bowling ball preferably has a thumb hole and two finger holes similarly and/or comparably arranged as the finger holes and thumb hole for a conventional bowling ball. The weight and size of the toy ball is light and small enough to be handled by a toddler. As preferred on the pin deck the spacing of the circles for the placement of the pins may be closer among each other than the spacing of conventional pins on a conventional pin deck so as to facilitate the knocking down of the pins by the toddler with the toy ball and the preferable weight and/or size of the toy bowling ball to the toy pin is substantially the same proportion as the weight and/or size of a standard bowling alley pin to a standard bowling ball and the more preferably size of the toy bowling ball is larger than the proportional size of a standard bowling ball to the size of a standard bowling alley pin to facilitate the knocking down of the pins by a toddler, however it is understood other spacing, weights, sizes and proportions are acceptable so long that such spacing, sizes, we and proportions are appropriate for toddlers. The toy pins are preferably of the same predetermined dimensions and the preferable height of the toy pins are from six to ten inches and it is understood other heights and/or dimensions are acceptable so long as the height and or dimensions of the toy pins are appropriate for toddlers.

Beyond that each of the toy pins are provided with a separate and different number from one to ten, preferably marked on a center surface of each pin, though it is understood other locations of the numbers on the pins are acceptable so long as the numbers are visible when the pins are upright and the same number on each pin may be replicated on each pin as preferred, and unless otherwise specified said pins, as preferred may also be provided with a different or same color or color scheme and/or marked with different shapes and/or patterns and/or characters such as animals and/or cartoon characters.

Non-limiting representative examples of scenarios of game play, learning to count and reinforcement scenarios are described below. However, the description of these particular scenarios of game play, learning to count and reinforcement thereof is not intended to limit the potential scope of other operational schemes and/or variety of learning scenarios possible using the available components and the interaction between the parent or caregiver who hereinafter is referred to as the parent, and a toddler. The parent would line up the toy pins, so that each numbered pin is matched with the corresponding numbered circle in numerical sequence from one to ten so that the toddler would learn to do the same. An object of the game is to knock over as many pins as possible with the fewest throws of the ball similar to an object of a standard bowling and another object of the game is to assist toddlers to learn to count whereby preferably when all the pins are off the circles the parent would instruct the toddler that the individually numbered pins are to be placed on the circles with the same corresponding numbers and in the numerical sequence from one to ten. Pin number one is placed with circle number one and pin number two is placed with circle number two and the same pattern of the placement of the numbered pins with the numbered circles in numerical sequence is repeated for all the pins and circles. When a toddler by throwing the ball knocks all the pins off the circles, the parent instructs the toddler that the individually numbered pins are to be placed over the circles with the same corresponding numbers and in the numerical sequence from one to ten. When the toddler places pin number one with circle number one the parent can praise the toddler such as by saying “very good you started with the number one” and subsequently when the toddler place pin number two with the circle number two the parent can say “yes you are right after one comes two” and the like and the parent would continue to reinforce the toddler's learning count from one to ten with the toddler placing all the numbered pins with the correct corresponding numbered circles in the correct numerical sequence from one to ten whereby the parent utilizing the first/embodiment of the invention can instruct and/or reinforce the toddler in learning to count from one to ten.

The second embodiment of the invention is the same as the first embodiment of the invention, which is incorporated into the second embodiment of the invention with the exceptions, and/or features as described herein and/or are adjusted accordingly. The second embodiment of the invention is a toy educational bowling game which assists toddlers to learn to count from one to ten and comprises ten toy bowling pins and a toy bowling ball and the description of the ball and pins in the first embodiment of the invention is incorporated into the second embodiment of the invention and subsequent embodiments of the invention and further more there is an impute device preferably located at the bottom of each pin, which device provides the data as to the number of the particular pin which can be transferred to and/or read by each of the circle's sensors which are described herein. Said impute device preferably is a barcode though it is understood that other impute devices may be used that substantially have similar effectiveness.

The second embodiment of the invention further comprises a base, similar to the base in the first embodiment of the invention with the exceptions and features as noted below. The top surface of the base forms said bowling pin deck with the pin set up guide as described in the first embodiment of the invention and the bottom surface of the base is to be placed on a supporting surface such as a floor. The base provides housing for the placement within and/or on, preferably within of the relevant electronics as described herein. The top surface of the base that forms the bowling pin deck preferably is elevated, and when elevated preferably at the front of the base there is a ramp or an incline. Each circle may be indented within the base as preferred, so as to make the placement of the pins unto the circles easier for the toddler. The base preferably forms a housing preferably having an open interior portion for the placement within and/or on and preferably within of the relevant electronics as described herein. The base preferably includes upper and lower sections respectively that are preferably interfittingly engaged and/or secured to form said housing. The top surface of the upper section of the base forms said bowling pin deck with the pin set up guide. The bottom surface of lower section half forms a flat support structure for supporting the base on a supporting surface such as a floor. The ramp or incline at the front edge of the base provides a generally planar bowling lane surface that angles upward from upon the supporting surface of the ramp such as a floor to the top surface of the base which is the pin deck to facilitate rolling of the bowling ball up onto the pin deck.

The base has a control system preferably integrated consisting of a microcontroller or a microprocessor with sufficient memory, though it is understood that there are electronic control devices which may be used that substantially have similar effectiveness, which responds with a light and/or lights and/or audio sounds to and/or from sensors whereby at least one sensor is located preferably within each circle on the base with any necessary wires and/or connecting and/or supporting elements to and/or from and/or for the other relevant electronics as described herein and actuated from an input device preferably located on the bottom of each pin. Said sensor preferably is a barcode reader though it is understood that other sensors in combination with other compatible impute devices may be used that substantially have similar effectiveness. The light and audio responses are more particularly described hereinafter.

The toy educational bowling game has a control device and/or control devices preferably a control switch and/or control switches which preferably are integrated within the base and said control device and control switches hereinafter is and/or may be referred to as a control switch and/or switches though it is understood any other comparable effective device and/or devices including remote control device and/or devices are acceptable. Said control sup itch has preferably three modes an off mode, lights on mode, and a lights and audio on mode which switch herein ager is referred to as the preferred control switch, or alternatively less preferably a control switch with two modes an off mode and on mode or lights and audio on mode which latter switch herein after is referred to as the less preferred control switch. Even less preferably there is a control device with an off mode or a light on mode or an audio on mode herein referred to as the least preferable control switch and the electronics would preferably consist of when there is said switch with light on mode to provide for the operations of the lights without the audio components and the electronics would preferably consist of when there is said switch with audio on mode to provide for the operations of the audio without the light components The control devices may include a device to control the volume preferably a volume control switch. The actuator of the switches or other control devices may be a toggle and/or dolly and/or rocker and/or a push-button and or any other comparable effective device and also and/or instead may be controlled by a remote control device.

The base has a lighting system and/or lights and/or a light preferably which may by located in the vicinity of each circle and which can be mounted on and/or flush with the surface of the base and/or within and/or behind an opening of the base and can be covered at least partially with translucent and/or transparent material such as translucent and/or transparent plastic so as to ensure when the light and/or lights and or lighting system is actuated that light is visible but preferably the lighting system and/or lights and/or a light is located behind the surface of the base and when located behind the surface of the base, the lighting system and/or lights and/or a light may be at least partially covered with translucent and/or transparent material such as translucent and/or transparent plastic which may be part of the surface of the base so as to ensure when the light and/or lights and or lighting system is actuated that light is visible and preferable the lighting system and/or lights and/or light are within and/or behind and/or over the number of each circle and more preferably within and/or behind the numbers and when within and/or behind the numbers, the numbers may be made at least partially of translucent and/or transparent material such as translucent and/or transparent plastic so as to ensure when the light and/or lights and or lighting system is actuated that light is visible and the lighting system and/or lights and/or light can emit at least one color, but more preferably can emit at least two or more different colors, and the preferably colors are green, yellow and/or red and are preferably able to flash and each color is shown preferably at different times. The lighting apparatus is preferable is a light-emitting-diode which hereinafter is and/or may be referred to as an LED and/or a liquid crystal display which hereinafter is and/or may be referred to as an LCD arrayed in front of a light source (backlight) or reflector though it is understood that there are other lighting apparatuses, which may be used that substantially have similar effectiveness.

The toy educational bowling game has an audio unit, which preferably comprises an integrated speech synthesizing circuit and a speaker. The audio unit and speaker preferably are integrated within the base and the speaker preferably is mounted on one of the surfaces of the base and/or within the base and preferably located in the front of the base. The base has relevant circuits, and/or wires, and/or electronics for connecting and driving the lights and the audio system, which preferably are integrated into the same circuit board and/or for connecting and/or driving the other herein described electronics. The electronic components are preferably powered by battery elements preferably housed within the base, and preferably connected by wires to the relevant circuits and/or electronics. The base may also have a socket connected by wires to the relevant circuits and/or other electronics, which can provide a connection to a commercial power supply for providing electrical power beyond and/or instead of battery-supplied power.

The toy educational bowling game's relevant electronics include electronic elements, which are suitable for either synthesizing desirable audio output and/or for outputting the desired audio responses as described herein from memory or other storage devices and/or for actuating the desired lighting system and/or lights and/or light responses as described herein from memory or other storage devices and preferably integrated within the base. The relevant electronics include any necessary electronic supporting and/or connecting elements and it is understood that the relevant electronics may be composed of any other functionally equivalent and/or comparable technologies including wireless technologies.

The toy bowling pins have preferably at the bottom of each pin an impute device which provides the data as to the number of the particular pin to the circle's sensor so when each pin's bottom is placed unto each circle, each circle's sensor reads and/or transfers the data from the impute device to a microcontroller, or other electronic control device so as to provide the audio and/or light responses as described herein.

Unless otherwise indicated herein, for the second embodiment and all other embodiment of the present invention it is preferred that besides the electronic elements and the supporting elements for the electronics which are child safe, that the major component elements of the present invention be molded or otherwise fabricated from a child safe, lightweight preferably polymer material (plastic) and/or a soft foam rubber, and/or hollow vinyl and however, it is to be understood that other materials, may be used which substantially have similar effectiveness and the elements of the present invention y be preferably fabricated in accordance with conventional fabrication techniques and the scope of the present invention is not intended to be limited by the recitation of any particular type of preferred material for any particular component part and/or preferred design, components, features, elements, operations, structures, constructions, game play learning scenarios nor by the recitation of any referred fabrication method.

All of the relevant referred to and/or contemplated and/or inferred and/or comparable and/or equivalent electronics and/or technologies and electronic responses including the light and audio responses and any necessary supporting and/or connecting elements described and/or contemplated and/or inferred and/or comparable equivalents thereof in the second embodiment of the invention and all other embodiments of the embodiments of the invention in which electronics are referred to and/or contemplated and/or inferred are well known in the art, and thereby no further description is necessary for one skilled in the art to make, assemble and operate any of the relevant referred to and/or contemplated and/or inferred and/or comparable equivalent electronics and/or technologies and electronic responses including the light and audio responses and any whereby when the pin number one is placed unto circle number one, preferably a green flashing light of said circle is turned on and each time a particular numbered pin is placed on a circle of a different number, the response is preferably that the lighting system and/or lights and/or a light of said circle does not turn on or alternatively less preferably a light with another color than green with the preferable color of red is turned on and preferably not flashing and when a particular numbered pin is placed on the same numbered circle out of the correct numerical sequence from one to ten, the response is preferable a light other than the color green is turned on for said circle with the preferable color of the light being yellow and the yellow light preferably does not flash and when the lower numbered pins are matched to the lowered numbered circles and whereby reach a pin and circle that was matched out of the numerical sequence form one to ten, then preferably the light of said circle turns from yellow to green which preferably flashes.

When the preferred control switch is placed into light system and audio system on mode, and preferably when all the pins are initially off the circles, each time that the particular numbered pin is placed upon the same corresponding numbered circle in proper numerical sequence from one to ten the lighting system and/or lights and/or light responds as previously described and the audio system responds by producing congratulatory and/or reinforcing phrases and/or phrases of instruction and the like and when a particular numbered pin is placed on a circle of a different number, the response of the light and/or lights and/or light system is the same as previously described and the audio system responds with phrases of correction and/or instruction and/or encouragement and the like and when a particular numbered pin is place unto a same numbered circle out of the correct numerical sequence from one to ten, the response of the light and/or lights and/or lighting system is the same as described above and the audio system responds with phrases of encouragement and/or instruction and/or reinforcing and/or congratulatory phrases and the like and when the lower numbered pins are matched to the lowered numbered circles which then reach a pin and circle that was matched out of the numerical sequence from one to ten, the response of the light and/or lights and/or lighting system s the same as described above and the audio system responds with phrases of encouragement and/or instruction and/or reinforcing and/or congratulatory phrases and the like. The same pattern of responses is repeated for the remaining numbered pins and circles.

Non-limiting representative examples of more detailed play and/or learning scenarios and their operations are described below. However, the descriptions of these particular scenarios and their respective operations with the responses of the lights and/or lighting system and/or light and/or audio system are not intended to limit the potential scope of other operational schemes and/or learning scenarios possible using the available components.

Non-limiting representative examples of operations and/or play and/or learning scenarios when the base's preferred control switch is on lighting system and audio system mode and preferably when all the pins are initially off the circles are described below.

If the toddler initially places pin number one on circle number one, a green light is turned on preferably flashing for circle number one and an audible sound is produced such as “Very good you sure know we start with one and that pin one goes on circle one or excellent you know that pin one goes with circle one, now you have pin one with circle one and since you know two comes after one place pin two with circle two” or if the toddler initially places pin number one on circle number two the light of circle number two is not turned on, and an audible sound is produced such as “sorry pin one does not go on circle two try again by placing pin one on circle one”. If the toddler then places the pin number one on circle number one, a green light is turned on preferably flashing for circle number one and an audible sound is produced such as “Very good you sure know we start with one and that pin one goes on circle one, now you have pin one with circle one and since you know two comes after one place pin two with circle two.”

If the toddler initially places pin number two on circle number two, a yellow light of circle two is turned on preferably not flashing and an audible sound is produced such as “Very good you sure know that pin two goes with circle two, but next time let's start with pin one by placing it on circle one, remember we start with one.” If the toddler then places the pin number one on circle number one, a green light is turned on preferably flashing for circle one, and an audible sound is produced such as “Very good you sure know that pin one goes with circle one, now you have pin one with circle one and pin two with circle two.” Then the light of circle number two turns from yellow to a green preferably flashing and an audio sound is then produced such as “Let's count one, two, and three, now place pin three with circle three.”

Non- limiting representative examples of play scenarios are similar to the play of conventional bowling and non-limiting representative examples of learning and/or play scenarios and their operations with the responses of the lights and/or lighting system and/or light and/or audio system are described below. However, the descriptions of any particular scenarios and/or representative examples of scenarios and their operations are not intended to limit the potential scope of other operational schemes and/or learning scenarios possible using the available components.

When the preferred control switch is placed into light system on mode, and preferably when all the pins are initially off the circles, each time that a particular numbered pin is placed upon the same corresponding numbered circle in proper numerical sequence from one to ten, the lighting system and/or lights and/or a tight responds by turning on the lighting system and/or lights and/or light of the said circle which preferably flashes and/or the preferable color of the lighting system and/or lights and/or light is green scenarios except there is no response from the audio system, so the parent can provide similar responses to that of the audio system.

For the second embodiment of the invention and all other embodiments of the invention which includes electronics, there may be the less preferred control switch with two modes and when said switch is in lights and audio on mode or on mode, the operations and the learning scenarios are the same or similar with the preferred control switch is in lights and audio on mode.

For the second embodiment of the invention and all other embodiments of the invention which includes electronics, there may be the least preferred control switch with two modes either off mode or lights on mode or off mode and audio on mode and when the switch has an off mode and a lights on mode and said switch is in light mode, the operations and the learning scenarios are the same or similar as with the preferred control switch and when said switch is in lights on mode or when the least preferred control switch has the off mode and audio on mode and when in audio on mode the operations and learning scenarios are the same or similar as described herein except without the light responses.

In the embodiments of the invention where circles are replaced with holes and in the vicinity of each hole is a light and/or lighting system and/or lights, the pattern of light and/or lights and/or lighting system and/or audio responses for the said holes is the same and/or similar as that for the circles and in the embodiments of the invention where the pins have a lights and/or a lighting system and/or a light, the pattern of light and/or audio responses is the same and/or similar as when the circles have lights and/or a lighting system and/or a light and in the embodiments of the invention where the pins and/or circles or holes have lights and/or lighting system and/or a light the pattern of light and/or audio responses is the same as when the circles have lights.

Less preferably for all the embodiments of the invention when the base has a light and/or a lights and/or a lighting system, the light and/or lights and/or lighting system need not be placed in the vicinity of each circle and/or hole and the operations and learning scenarios are adjusted accordingly.

The third embodiment of the invention is the same as the second embodiment of the invention which is incorporated into the third embodiment of the invention except that the base does not have the preferred ramp and the base is in the preferable shape similar to a triangle, though it is understood other shapes are acceptably and the base is supported by legs, preferably three legs and each supporting leg is preferably located near the farthest outer edge of the base from the center of the base in approximately equal distance from each other so as to provide suitable support for the base, though it is understood other number of legs and locations of the legs are acceptable so long as to provide adequate support for the base and room for the pins to be placed in the hereinafter described holes of the base which replaces and/or substitutes for the ten circles and each of the said holes have a different individual number from the set of numbers from one to ten marked in their vicinity in numerical order and preferably each number is below and/or in front of each hole similar and/or the same to when each number is marked in front of each circle numerical order forming the pin deck as previously described. The holes are aligned similarly to the circles which form the pin set up guide.

There is at least one sensor preferably located on the inner side of each hole and each pin has an impute device preferably located on the side surface of the pins, so when the pins are placed into the holes the impute devices lines up with the holes' sensors and transfers the data as to the number of the pin to the sensor of the hole.

The base has a lighting system and/or lights and/or light including necessary wires, and/or connecting and/or supporting elements, to and/or from and/or for the other previously described electronics and said lighting system and/or lights and/or light of each hole functions and responds and are located as for lighting system and/or lights and/or light for each circle as previously described preferably below each hole and behind each number and when behind said numbers, said numbers preferably are at least partially made of translucent and/or transparent material such as translucent and/or transparent plastic to ensured visibility when activated and the ten holes which replaces the ten circles or markings on the base are arranged as the same or similarly as the circles whereby each of ten holes with each respective number are aligned as the circles and numbers for the previously described pin set up guide and/or in the same or similar form as when conventional bowling pins are lined up for the beginning of play of a conventional bowling.

The individually numbered pins are to be matched by their placement into to the same numbered. holes in numerical sequence from one to ten which is similar to the previously described matching of the pins to the circles. For the placement of the pins into the holes, the width of each hole is preferably wide enough so that a pin at its widest width can fit into each hole without undue difficulty and preferably the height of the base is approximately the same height at which the pin's width is at its widest from the bottom of the pin, which also is where preferably the pin's impute devices lines up with the sensors of the holes, however other heights of the base and the widths of the pins and/or holes are acceptably so long as the height of the base and the widths of the pins and/or holes satisfies the other herein described features between the holes of the base and pins, and does not become over cumbersome for a toddler to maneuver the pins into the holes.

Each sensor preferably located on inner side of each hole has the necessary wires and/or connecting and/or supporting elements to and/or from and/or for the other relevant electronics as previously described. Preferably the base is light enough that so when the toddler successfully places the pins in the proper sequence, the toddler with or without the assistance of the parent can remove the base from the pins, so as to be able to ready the pins for the ball.

Non-limiting examples of operations and play and learning scenarios with e responses of the lights and/or lighting system and/or light and/or audio system are similar to the previous described non-limiting examples of operations and scenarios except that the lighting system and/or lights and/or light of the circles are replaced with the lighting system and/or lights and/or light of the holes and/or audio responses.

The fourth embodiment of the invention is the same as the second embodiment of the invention which is incorporated into the fourth embodiment of the invention, except instead and/or in addition that the base has a lighting system and/or lights and/or light, each pin has a lighting system and/or lights and/or light as previously described including any necessary wires and/or connecting and/or supporting elements to and/or from and/or for the other relevant electronics as previously described to enable the activation of the lighting system and/or lights and/or light of the pins with responses in the same and/or similar manner as previously described for the responses of the lighting system and/or lights and/or light on the base, and the lighting system and/or lights and/or light can be mounted on the surface of each pin and/or flush with said surface and/or within and/or behind an opening of said surface or preferably behind a translucent and/or transparent surface of the pin and/or can be covered at least partially with translucent and/or transparent material such as translucent and/or transparent plastic and/or the pins may be partially or completely made of such translucent and/or transparent material so when a light is actuated the light is assured to be visible and preferably the lighting system and/or lights and/or light of the pins would be behind each number of the pin.

The lighting apparatus is preferably is a LED though it is understood that there are other lighting apparatuses which may be used that substantially have similar effectiveness and the lighting system and/or lights and/or light are preferably behind the number of each pin, and when behind said numbers, said numbers preferably are at least partially made of translucent material such as translucent plastic so when a light is actuated the light is assured to be visible from behind the number, and/or each pin may have or be covered with a LCD preferably located at or in the vicinity of the number of each pin and arrayed in front of a light source (backlight) or reflector , and the electrical connection of the light of each pin to each circle preferably is at the bottom of each pin to each circle which has the necessary wires and/or connecting and/or supporting elements to and/or from and/or for the other relevant electronics as previously described, and/or each circle and pin has lights and/or light and/or lighting system as previously described and responds as previously described.

Non limiting examples of operations and/or play and/or learning scenarios with the responses of the lights and/or lighting system and/or light and/or audio system are similar and/or the same as the previously described non-limiting examples of operations and/or play and/or learning scenarios including the lighting system and/or lights and/or light of the base and/or the audio responses.

A fifth embodiment of the invention is the same the third embodiment of the invention, which is incorporated into the fifth embodiment of the invention and except instead and/or in addition that the base has a lighting system and/or lights and/or light, each pin has a lighting system and/or lights and/or light as previously described including any necessary wires, and/or connecting and/or supporting elements to and/or from and/or for the other relevant electronics to provide for activation and in the same or similar manner as previously described for the responses of the lighting system and/or lights and/or light on the base, and the lighting system and/or lights and/or light can be mounted on the surface of each pin and/or flush with said surface and/or within or behind an opening of said surface or preferably behind at least partially a translucent and/or transparent surface of the pin and/or can be covered at least partially with translucent and/or transparent material such as translucent plastic and/or the pins may be partially or completely made of such translucent and/or transparent material so when a light is actuated the light is assured to be visible and preferable the lighting system and/or lights and/or light of the pins would be behind each number of the pin. The lighting apparatus preferably is a LED though it is understood that there are other lighting apparatuses which may be used that substantially have similar effectiveness. The lighting system and/or lights and/or light are preferably behind the number of each pin, and when behind said numbers, said numbers are preferably at least partially made of translucent and/or transparent material such as translucent and/or transparent plastic so when a light is actuated the light is assured to be visible from behind the number, and/or each pin may be covered with a LCD preferably located at or in the vicinity of the number of each of pin and arrayed in front of a light source (backlight) or reflector, and each hole has the necessary wires and/or connecting and/or supporting elements to and/or from and/or for the other relevant electronics as described herein and the electrical connections of the pins preferably are on the side of the pins from the light and/or light and/or or lighting system, so that when a pin is placed into the hole the electrical connection of the pin would line up with the electrical connection located on the inner side of the hole which has the necessary wires and/or connecting and/or supporting elements to and/or from and/or for the other relevant electronics as previously described or each hole and each pin has lights or a light and/or lighting system as previously described and responds as previously described.

Non-limiting examples of operations and/or play and/or learning scenarios with the responses of the lights and/or lighting system and/or light and/or audio system are similar and/or the same as the previously described non-limiting examples of operations and/or play and/or learning scenarios.

The sixth embodiment of the invention is the same as the first embodiment of the invention which is incorporated herein, with the exceptions and/or features as described herein whereby each pin and/or circle and/or in the vicinity of each circle may or may not have a number but instead or in addition each pin has and/or is different color from a set of ten different colors and/or is covered completely or partially with a different color from the same set of colors such as white, red, yellow, orange, green, purple, turquoise, brown, blue, gray or any other set of ten colors as preferred and/or shade and/or shades of a color thereof and each circle is a different color from the same set of ten colors and/or shade and/or shades of a color thereof whereby preferably each circle is at least partially but preferably completely covered with a different color from the same set of colors and/or shade and/or shades of a color thereof and as preferred when each pin and/or circle has a number and a color and/or shade and/or shades of a color thereof, the color and/or shade and/or shades of a color thereof and the number of each pin matches to a circle with the same color and/or shade and/or shades of a color thereof and the same number. As preferred each pin and/or circle and/or in the vicinity of each circle may have the particular color of the pin, and/or circle marked or written thereupon preferably in the same or similar locations where the numbers are marked in the first embodiments of the invention and when each pin and/or circle has a number, the color of the pin and/or circle may be preferably marked and/or written in the vicinity and more preferably next to the respective number of each pin and/or circle. Preferably when the color of the pin and/or circle is written thereupon, the color of the written letters-may be at least partially and preferably completely be of the same color that is written.

Non-limiting examples of the operations and play and learning scenarios are similar to the previous described operations and play and learning scenarios except that they are in regard when there are numbers to either the matching or not matching of the number pins to the number circles and/or to the matching or not matching of the color pins to the color circles and when there are not numbers they are just in regard to the matching or not matching of the color pins to the color circles.

The seventh embodiment of the, invention is the same as in the first and sixth embodiment of the invention which is incorporated herein, with the exceptions and/or features as described herein whereby each pin and marking and/or in the vicinity of each marking marked on it and/each marking and/or the vicinity of each marking is a different shape from a set of ten different shapes such as a square, rectangle, star, circle, triangle, octagon, pentagon, crescent, oval, sphere or any other set of ten shapes as preferred, or a set often shapes similar to such as squares, rectangles, stars, circles, triangles, octagon, pentagon, crescent, oval, sphere or any other set of ten shapes as preferred and each pin is marked with a different shape from the same set of shapes and when marked with a number and/or color and/or a shade and/or shades of a color thereof matches to a marking and/or near the marking on the base with the same shape and/or number and/or color a shade and/or shades of a color thereof As preferred, each pin, and/or marking may have the particular shape of the pin, and/or marking written thereupon preferably in the same or similar locations where the numbers are marked in the first embodiments of the invention and/or where the numbers are marked and/or where the colors are written in the first and/or sixth embodiments of the invention.

Non-limiting examples of operations and play and learning scenarios with the responses of the lights and/or lighting system and/or light and/or audio system are similar to the previous described operations and play and learning scenarios except that they may or may not only be in regard to the matching or not matching of the numbered and/or colored pins to the numbered and/or colored circles but stead or also in regard to the matching or not matching of the pins marked with particular shapes to markings with particular shapes and/or in the vicinity of the markings marked with particular shapes.

The eight embodiment of the invention is the same as the first, sixth and seventh embodiments of the invention which are incorporated herein, with the exceptions and/or features as described herein whereby each pin and marking and or n the vicinity of each marking may or may not have a number and/or a color and/or a shape from a set of shapes with the other features and elements and operations and play and learning scenarios as previously described and/or selected combinations and/or components thereof as preferred and/or are adjusted accordingly and/or as preferred, and that instead or in addition each marking and/or in the vicinity of each marking is a different letter from a set of the first ten letters of the alphabet and each pin is marked with a different letter from the same set of letters and when marked with a number and/or shape and/or color and/or a shade and/or shades of a color thereof matches to a marking and/or in the vicinity of the marking on the base with the same number and/or shape and/or color a shade and/or shades of a color thereof.

Non-limiting examples of operations and play and learning scenarios with the responses of the hats and/or lighting system and/or light and/or audio system are similar to the previous described operations and play and learning scenarios except that they may or may not only be in regard to the matching or not matching of the numbered and/or colored pins and/or marked with shapes to the numbered and/or colored markings and/or markings and/or in the vicinity of the markings with the described set of shapes but instead or also in regard to the matching or not matching of the pins marked particular letters to markings and/or in the vicinity of the markings marked with the

Further embodiments of the invention incorporates the second, third, fourth, and fifth embodiments of the invention and further includes that each pin and/or marking and/or hole may or may not have a number with the other features and elements and operations and play and learning scenarios as previously described and/or selected combinations and/or components thereof as preferred and that instead or in addition each pin has and/or is at least partially a different color from a set often different colors and/or shade and/or shades of a color thereof and/or is covered at least partially but preferably nearly completely or completely with different color from the same set of colors such as such as white, red, yellow, orange, green, purple, turquoise, brown, blue, gray and/or shade and/or shades of a color thereof or any other set of ten colors and/or shade and/or shades of a color thereof as preferred and each marking or hole and/or surrounding the hole is and/or has a different color from the same set of ten colors and/or shade and/or shades of a color thereof whereby preferably each marking and/or hole is at least partially and preferably completely covered with a different color from the same set of colors and/or shade and/or shades of a color thereof.

Preferable, each pin, and/or marking and/or hole has the particular color of the pin, and/or circle marked or written thereupon preferably in the vicinity of where the numbers are or could be and preferable the written letters of the marked color are at least partially but more preferably completely of the same color and/or shade and/or shades of a color of the particular pin an circle and/or hole

As preferred each pin and/or marking and/or hole and/or surrounding each hole may be made at least partially of translucent material with a different color from the same set of colors and/or shade and/or shades of a color thereof whereby when a light and/or lights and/or lighting system of the pin and/or marking and/or hole is actuated the light may be of a neutral color such as white so when activated, the color of the translucent material maybe highlighted.

When there are numbers and colors, there is control device preferably a switch for color mode or number mode and said control device is hereinafter referred to as the multifunction switch and each circle or hole with its particular color and/or shade and/or shades of a color thereof and number matches to a pin with the same color and/or shade and/or shades of a color thereof and number; each circle, and/or hole and/or pin has a circle or hole or alternatively less preferably the color of the light is another color and said color is preferably green and if a pin of a particular color and/or shade and/or shades of color thereof is matched with a circle or hole of a different color, the preferably response is the light and/or lights and/or lighting system of said circle or hole and/or pin either does not turn on or alternatively less preferably another color light is turned on with the preferably color of red which preferably does not flash and when the preferred control switch is placed into light system and audio system on mode and preferably when all the pins initially are off the circles or not in the holes, each time that a pin with a particular color and/or shade and/or shades of a color thereof is placed on a circle or in a hole with the same color and/or shade and/or shades of a color thereof, the light and/or lights and/or lighting system responds as previously described and the audio system responds by producing congratulatory and/or reinforcing and/or instructional and/or encouraging phrases and the like, and when a pin with particular color and/or shade and/or shades of a color thereof is placed on a circle or in a hole of a different color and/or shade and/or shades of a color thereof, the response of the lights and/or light and/or lighting system the same as previously described and the audio system responds with phrases of correction and/or instruction and/or encouragement and the like.

When the pins and/or markings and/or holes have numbers and/or when multifunction switch is in number mode, the same or similar operations and responses and learning scenarios are made as previously described for the matching or not matching of the numbered pins with the numbered circles or holes in or out of numerical sequence from one to ten as previously described. When the pins and/or markings and/or holes do not light or lights and/or lighting system as previously described which can preferably also emit at separated tunes one of ten different colors and/or shades of colors thereof from the same set of colors. When the pins, and/or markings and/or holes do not have numbers and/or when the multifunction switch is in color mode and when the control switch is not in off mode, the impute device of each pin can transfer the data to the markings' or holes' sensors as to the color of each pin and the electronics operates and responds with play and/or learning scenarios not to the matching or not matching of the number pins to the number circles or holes but instead in regard to the matching or not matching of the color pins to the color circles/arid/or holes.

The non-limiting examples of play and/or learning scenarios and their operations with the responses of the lights and/or lighting system and/or light and/or audio system are described below and are not intended to limit the potential scope of other operational schemes and/or scenarios possible using the available components.

When there are not numbers and/or when the multifunction switch is in color mode and when the preferred control switch is on light on mode and preferably when initially all the pins are off the circles or not in the holes, each time that the pin with the same color and/or shade and/or shades of a color thereof is placed on the or in a hole with the same color and/or shade and/or shades of color thereof, the fight and/or lights and/lighting system responds by turning on the light and/or lights and/or lighting system of the said circle or hole and/or pin, which preferable flashes and the preferable color of the light is the same color and/or shade and/or shades of a color thereof of the pin and/or have numbers and when there is not a multifunction switch then the operations and learning scenarios are in regard to matching of the pins with the same color and/or shade and/or shades of a color thereof to the markings and/or holes with the same color and/or shade and/or shades of a color thereof

Still further embodiments of the invention incorporates all the other embodiments of the invention with electronics and includes that each pin and/or marking and/or hole and/or in the vicinity of each marking and/or hole may or may not have a number and/or a color with the other features and elements and operations and play and learning scenarios as previously described and/or selected combinations and/or components thereof as preferred and that instead or in addition that around or in the vicinity of each hole and/or each marking and/or each marking itself as preferred and/or preferably located below each hole and/or marking has and/or is a different shape from a set of ten different shapes such as a square, rectangle, star, circle, triangle, octagon, pentagon, crescent, oval, sphere or any other set of ten shapes as preferred, or a set of ten shapes similar to such as square, rectangle, star, circle, triangle, octagon, pentagon, crescent, oval, sphere or any other set of ten shapes as preferred and each pin is marked with a different shape from a same set of ten shapes as that of the markings and/or holes and when there are the described numbers and/or colors each pin is marked with a shape, and/or number and/or color that matches to a hole or marking and/or in the vicinity of each hole and/or marking with the same shape and/or number and/or color.

The light and or lights and or lighting system is as previously described and/or adjusted accordingly and/or as preferred and/or as an expansion of the same lighting system and/or lights and/or adjusted accordingly and/or as preferred and/or a separate lighting system and/or light and/or lights and/or adjusted accordingly and may similarly be placed behind and/or in the vicinity of each shape as preferred and assured to be visible as previously described.

When there are the described numbers and/or colors, there is a control device preferably a switch with a number mode and/or shape mode and/or color mode, hereinafter referred to as the multifunction switch. When the multifunction switch is in shape mode, and when the control switch is not in off mode, the impute device of each pin can transfer the data to the markings' or holes' sensors as to the shape of each pin and the electronics operates and responds with learning scenarios not in regard to the matching or not matching of the number pins to the number circles or holes but instead in regard to the matching or not matching of the shapes marked on the pins to the shapes of the markings and/or in the vicinity of each marking and/or holes.

Non-limiting examples of operations and/or learning scenarios are similar to the examples of the scenarios of the previous embodiments of the invention, except whereby the responses are in regard to the matching or not matching of the pins with markings of particular shapes to markings of particular shapes and/or in the vicinity of each marking of particular shapes and/or holes. However, the descriptions of these previously described non-limiting scenarios and/or operations or the following more detailed non-limiting described scenarios and/or operations are not intended to limit the potential scope of other operational schemes and/or scenarios possible using the available components.

When the multifunction switch is in shape mode and the preferred control switch is in light on mode and preferably when initially all the pins are off the markings or out of the holes and each time that a pin marked with a particular shape is placed on the marking with the same shape and/or marking with the same shape in its vicinity and/or in the hole marked with the same shape in its vicinity, the light or lights and/or lighting system for that particular marking and/or pin and/or hole responds by being turned on, and the light and/or lights and/or lighting system preferable flashes and the preferable color of the light is green and if a pin with a particular shape is placed on marking of a different shape and/or marking with the different shape, in its vicinity or in a hole marked with a different shape, the preferably response is the light and/or lights and/or lighting system of said marking or hole and/or pin does not turn on or alternatively less preferably the light and/or lights and/or lighting system is turned on preferably with the color red and preferably not flashing and when the preferred control switch is placed into light system and audio system on mode and preferably when initially all the pins c off the markings and/or not in the, holes an then each time that a pin with the particular shape is placed with the same shape marking and/or marking with the same shape in its vicinity or hole marked with the same shape, the light and/or lights and/or lighting system responds as previously described and the audio system responds by producing congratulatory and/or reinforcing and/or further instructional phrases and the like, and each time that a pin with a particular marked shape is placed with a marking or hole with a different shape and/or marking and/or hole with the different shape in its vicinity, the response of the light and/or lights and/or lighting system is the same as previously described and the audio system responds with phrases of correction and/or instruction and/or encouragement and the like. When the control switch is not in off mode and when the multifunction switch is in number mode, the same or similar responses and operations and learning scenarios are made for the matching or not matching of the numbered pins numbered and/or holes in or out of numerical sequence from one to ten as previously described and multifunction switch is in color mode, the same or similar responses and operations and learning scenarios are made for the matching or not matching of the colored pins to the colored markings and/or holes as previously described.

Preferred embodiments of the invention incorporates all the other embodiments of the invention with electronics and includes that each pin and/or marking and/or hole and/or in the vicinity of each marking and/or hole may or may not have a number and/or a color and/or a shape with the other features and elements and operations and play and learning scenarios as previously described and/or selected combinations and/or components thereof as preferred and that instead or in addition that around or in the vicinity of each hole and/or each marking and/or each marking itself as preferred and preferably located below each hole and/or marking is or has a different letter of the alphabet preferably from the set of the first ten letters of the alphabet arranged in alphabetical order similar o the alignment of the numbers in numerical order and each pin is marked with a different letter of the alphabet from a same set of letters as that of the markings and/or holes and when there are numbers preferably each letter may be adjacent or in the vicinity of each number and when each pin and/or marking and/or hole and/or in the vicinity of each marking and/or hole has a number and/or a color and/or a shape, there is a control device preferably a switch for number mode and or shape mode and/or color mode and/or letter mode hereinafter referred to as the multifunction switch and when the markings and/or holes and/or pins and/or in the vicinity of the marking and/or hole have numbers and/or colors and/or shapes, each marking and/or hole and/or in the vicinity of the marking and/or hole has the same letter and/or shape and/or number and/or color and/or shade and/or shades of a color thereof that matches to a pin with the same letter and/or shape and/or number and/or color and/or shade and/or shades of a color thereof. When the multifunction switch is n letter mode and the control switch is not in off mode, the impute device of each pin can transfer the data to the markings' or holes' sensors as to the letter of each pin and the electronics operates and responds with play and/or learning scenarios not in regard to the matching or not matching of the number pins to the number circles or holes and/or the other previously described matching but in regard to the matching or not matching of the letters of the pins to the letters of the marking holes,

When the multifunction switch in letter mode and the control switch is not in off mode non-limiting examples of operations and/or learning scenarios are similar to the examples of the scenarios of previous embodiments of the invention, except whereby the responses are in regard to the matching or not matching of the pins with markings of particular letters to markings and/or holes with the same letter. However, the descriptions of the detailed described scenarios and/or operational schemes are not intended to limit the potential scope of other operational schemes and/or scenarios possible using the available components.

When the multifunction switch in letter mode and the preferred control switch n light on mode and preferably when initially all the pins are off the markings and/or out of the holes and each time that a pin marked with a particular letter is placed on the marking with the same letter and/or marking with the same letter in its vicinity and/or in the hole marked with the same letter its vicinity, the light and/or lights and/or lighting system for that particular marking and/or the light or lights and/or lighting system of the pin responds by being turned on, and the light preferably flashes and the preferable color of the light is green and if a pin with a particular letter is placed on marking of a different letter and/or marking h the different letter in its vicinity and/or in a hole with a different letter in its vicinity, the preferable response is the light and/or lights and/or lighting system of said marking or hole and/or pin either does not turn on or alternatively less preferably the light and/or lights and/or lighting system is turned on preferably that of the color red and preferably not flashing and when the preferred control switch is placed into light system and audio system on mode and preferably when initially all the pins are off the marking or not in the holes and each time that a pin with a particular/letter is placed with a marking or hole marked with the same letter and/or marking with the same letter in its vicinity, the light and/or lights and/or lighting system responds as previously described and the audio system responds by producing congratulatory and/or reinforcing and/or further instructional phrases and the like, and each time that a pin with a particular marked letter is placed with a marking or of a different letter and/or marking with the different letter its vicinity or hole with the same different letter in its vicinity, the response of the light and/or lights and/or lighting system is the same as previously described and the audio system responds with phrases of correction and/or instruction and/or encouragement and the like and when the multifunction switch is in number mode, the same operations and responses and learning scenarios are made as previously described and when said switch is in color mode the same operations and responses and learning scenarios are made as previously described and when said switch is in shape mode the same operations and responses and learning scenarios are made as previously described.

When the pins and/or markings and/or holes do not have numbers and colors and shapes and when there is not a multifunction switch then the operations and learning scenarios are in regard to matching of the pins with the same letter to the markings with the same letter and/or holes marked with the same letter.

Furthermore the most preferred embodiments of the invention incorporates all the previous embodiments of the invention that includes electronics except the pins and/or holes and/or markings may or may not have permanently marked numbers, and/or colors, and/or shapes and/or letters but instead and/or in addition there is a control device preferably a switch hereinafter referred to as the multifunction switch to provide a choice at any time to display among the previously described numbers, and/or shapes, and/or colors, and/or letters and their respective operations and/or learning scenarios of the toy switch is in color mode and the control switch is not in off mode the LCD or LED or other lighting apparatus displays on the pins and/or markings and/or holes and/or in the vicinity of the markings and/or holes the previously described colors, and operates the toy educational bowling game's electronics pursuant to the previously described color mode operations and/or responses and/or learning scenarios or when the multifunction switch is in shape mode and the control switch is not in off mode the LCD or LED or other lighting apparatus displays on the pins and/or markings and/or holes and/or in the vicinity of the markings and/or holes the previously described shapes, and operates the toy educational bowling game's electronics pursuant to the previously described shape mode operations and/or responses and/or learning scenarios or when the multifunction switch is in letter mode and the control switch is not in off mode the LCD or LED or other lighting apparatus displays on the pins and/or markings and/or holes and/or in the vicinity of the markings and/or holes the previously described letters in alphabetical order as previously described, and operates the toy educational bowling game's electronics pursuant to the previously described letter mode operations and/or responses and/or learning scenarios.

There may be additional mode on the said switch or separate control device preferably a switch for the first ten letters mode, the second ten letters mode, and the last six letters mode of the alphabet, whereby when preferably all the pins are on the circles and/or in the holes and when the multifunction switch has the first ten letters mode, the second ten letters mode, and the last six letters mode and or separate switch with the first ten letter mode, the second ten letters mode, and the last six letters mode and when either of said educational bowling game whereby each pin and/or hole and/or marking has a light and or lights and or lighting system as previously described and/or adjusted accordingly and/or as preferred and/or as an expansion of the same lighting system and/or lights and/or adjusted accordingly and/or as preferred and/or a separate lighting system and/or light and/or lights and/or adjusted accordingly and/or as preferred composed of the LED or a LCD arrayed in front of a light source (backlight) or reflector and/or other lighting apparatus preferably located in the vicinity and/or same location of the previous described lights and/or lighting system with any necessary supporting elements and connection to and/or from the other relevant described electronics. Said expanded lights and/or lighting system or the separate lights and lighting system can display the previously described numbers, or colors or shapes or letters at any particular time as preferred and is actuated from memory or other storage devices with the necessary electrical and/or wireless connections from the storage device to and/or from the said expanded lights and/or lighting system or the separate lights and lighting system.

The multifunction switch which a number mode and color male and/or shape mode and/or letter mode and when preferably initially all the pins are on the markings or in the holes and when the multifunction switch is in number mode and the control switch is not in off mode, the LCD or LED or other lighting apparatus displays on the pins and/or markings and/or holes and/or in the vicinity of the markings and/or holes the previously described numbers arranged in numerical order as previously described, and operates the toy educational bowling games electronics pursuant to the previously described number mode operations and/or responses and/or learning scenarios or when the multifunction switches is in the first ten letter mode and the control switch is not in off mode the LCD or LED or other lighting apparatus for each marking and/or hole anchor pin displays a different letter of the alphabet of the first ten letters of the alphabet arranged in alphabetical order and the toy educational bowling game's electronics operates pursuant to the previously described letter mode operations and/or responses and/or learning scenarios and when either of said switches is in the second ten letter mode and the control switch is not in off mode the LCD or LED or other lighting apparatus for each marking and/or hole and/or pin displays a different letter of the alphabet from the second ten letters of the alphabet arranged in alphabetical order and the LCD or LED or other lighting apparatus and the toy educational bowling game's electronics operates pursuant to the previously described letter mode operations and/or responses and/or learning scenarios and when either of said switches is in the last six letters mode and the control switch is not in off mode the LCD or LED or other lighting apparatus for each of the first six markings and/or holes and/or pins displays a separate and different individual letters of the last six letters of the alphabet arranged in alphabetical, and the toy educational bowling game's electronics operates pursuant to the previously described letter mode operations and/or responses and/or learning scenarios.

Further even still other embodiments of the invention incorporates any and/or all other embodiments of the invention and instead of set ten numbers from one to ten, ten pins, ten markings and/or ten holes, and/or the same set of ten colors and/or a same set of ten shapes and/or the same set of ten letters there are instead are set of six numbers from one to six, six pins, six markings and/or holes, and/or a same set of six shapes, and/or a same set of six colors and/or the same set of six letters and the described and/or contemplated and/or inferred operations, components, elements, electronics, alignments, responses and learning scenarios are adjusted accordingly or alternatively any other set of numbers, and the operations, components, elements, electronics, alignments, responses and learning scenarios are adjusted accordingly, however the preferred set of numbers is one to six with six pins, six markings and/or holes, and/or a same set of six shapes, and/or a same set of six colors and/or the same set of six letters and the most preferred set of numbers is one to ten with ten pins, ten markings and/or ten holes, and/or a same set of ten colors and/or a same set of ten shapes and/or the same set of ten letters.

Further even still other embodiments of the invention include any and/or all of the previous embodiment of the invention which are incorporated here with additional features as preferred and the non-limiting examples of additional features include the number and/or shape and/or color and/or letter and/or any combinations thereof as preferred of the markings and/or hole and/or pins may be replicated in the same or any other size as preferred on the base so that when a pin is placed upon the marking a replicated marking may still be visible whether the marking is a number and/or color and/or shape and/or letter and/or any combinations thereof as preferred and/or as preferred each pin may be marked with a different three dimensional shape on the bottom or the base of each pin from the same set of shapes and/or same set of numbers and/or the same set of letters as previously described and/or as preferred which can fit into the same shaped hole and/or placed in an indentation of the marking with the same shape, whereby the particular shape at the bottom or the base of each pin can fit into and/or unto a hole of the same shape and/or marking and/or other light or audio responses may be made such as when the pins are struck with the ball, knocking and/or wobbling sounds may be produced and/or cheering and/or clapping sounds and/or any other sound and/or phrases as preferred may be produced and/or the flashing of the light and/or lights and/or lighting system may be produced as preferred and the like may be additional features as preferred.

Further even still other embodiments of the invention incorporates all previous embodiments of the invention and further includes that various individual components and/or features and/or operations including previously described and/or contemplated and/or inferred numbers and/or shapes and/or colors and/or letters of the pins and/or circles and/or markings and/or holes and their previously described and/or contemplated and/or inferred and/or adjusted respective alignments, and/or spacing and/or matching of the pins' numbers and/or shapes and/or colors and/or letters with the circles and/or markings and/or holes with the same numbers and/or shapes and/or colors and/or letters, and/or described and/or contemplated and/or interred and/or adjusted elements and/or described and/or contemplated and/or adjusted and/or inferred designs and/or contemplated and/or inferred and/or adjusted features with any corresponding and/or described and/or contemplated and/or inferred electronics and/or adjusted electronics and/or technologies and/or contemplated and/or adjusted lights and/or lighting system and/or various described and/or contemplated and/or adjusted control devices and/or switches and/or complementary and/or supporting and/or contemplated and/or inferred and/or described and/or adjusted operations and/or supporting and/or contemplated and/or described and/or adjusted and/or inferred components and/or features and/or elements and/or the corresponding and/or contemplated and/or described and/or inferred and/or adjusted responses and/or adjusted and/or contemplated and/or inferred and/or described learning scenarios and/or supporting and/or contemplated and/or described and/or inferred and/or adjusted locations of the different described elements and/or features can be employed in any combination as preferred and adjusted accordingly and/or as preferred and any and/or all of the preferred and/or adjusted combinations of the above constitutes additional embodiments of the invention.

For all the embodiment of the invention that utilizes lights, the lights can be turned off at the end of the learning scenarios as preferred.

All of the relevant referred to and/or contemplated and/or inferred and/or comparable and/or equivalent electronics and/or technologies and electronic responses including the light and audio responses and any necessary supporting and/or connecting elements described and/or contemplated and/or inferred and/or comparable equivalents thereof in any and/or all embodiments of the embodiments of the invention in which electronics are referred to and/or contemplated and/or inferred are well known in the art, and thereby no further description is necessary for one skilled in the art to make and assemble and operate any of the relevant referred to and/or contemplated and/or inferred and/or comparable and/or equivalent electronics and/or technologies and electronic responses including the light and audio responses and any necessary supporting and/or connecting elements described and/or contemplated and/or inferred and/or comparable equivalents thereof.

Toddler and/or toddlers also refers herein to a young child and/or children of different ages and when appropriate to expand and/or maximize the utility of the invention and the features and/or operations and/or elements and/or components and/or designs of the invention are adjusted accordingly and/or as preferred and/or as contemplated and/or as inferred.

For the embodiments of the invention with electronics, the electronics can be adjusted accordingly to each embodiment as appropriate and/or preferred and/or as contemplated and/or as inferred.

While there is described and/or shown herein, certain specific structures embodying the invention, it will be manifest to those skilled in the art that various modifications and rearrangements of the parts and/or components and/or features and/or elements and/or designs and/or electronics and/or responses and/or learning scenarios and/or use of different languages and/or use of other alphabets besides the twenty-six letter standard English alphabet and/or other numerals may be made without departing from the spirit and scope of the underlying inventive concept and that the same is not limited to the particular forms herein described and/or shown.

In the different embodiments of the toy educational bowling game of the present and matching the pins to the markings and/or holes. When one player has managed to knock down all the pins, the pins can be set up again for and/or according to the various described and/or contemplated and/or inferred scenarios, the turn can then move to the next player. The objects of the game can be to knock down all the pins in as few attempts as possible while learning to count from one to ten and/or learning different colors and/or shapes and/or letters of the alphabet n preferably as few different attempts as possible.

Written and/or audible instructions for the size toy educational bowling game can also be provided pursuant to the herein description and/or contemplative and/or inferred use thereof

Numerous objects, features and advantages of the present invention will be readily apparent to those of ordinary skill in the art upon a reading of the herein detailed description of presently described embodiments of the present invention. In this respect, it is to be understood that the invention is not limited in its application to the details of construction and/or operations and/or elements and/or features and/or structures and/or game play and learning scenarios and/or designs and/or to the arrangements of the components as set forth in the description. The invention is capable of other embodiments including various combinations of the different components, features, elements, operations, designs, structures, constructions, game play and learning scenarios, and of being practiced and carried out in various ways. Also, it is to be understood that the phraseology and terminology employed herein are for the purpose of description and should not be regarded as limiting as to other possible embodiments of the invention, which are within the spirit, and the scope of the present invention.

As such, those skilled in the art will appreciate that the conception, upon which this disclosure is based, may readily be utilized as a basis for the designing of other structures, features, operations, designs, methods and systems for carrying out the several purposes of the present invention and the equivalents thereof. It is important, that the specifications be regarded as including equivalents including such equivalent constructions and various combinations of the different components, features, designs elements, operations, systems, game play and learning scenarios and equivalents thereof, insofar as they do not depart from the spirit and scope of the present invention.

The present invention fulfills the need for a fun, new type of coordination game. The appealing features of the bowling game of the present invention include its ease of use.

The invention has learning and/or entertainment value. A key factor in the appeal of the toy educational bowling game of the present invention is its design for toddlers who can play and learn from the game, which takes timing and coordination to effectively hit the pins. The challenge presented by the toy educational bowling game of the present invention can keep a toddler entertained and engaged in learning for extended periods of time. Children can practice together and have contests for knocking down all the pins in the fewest attempts and have contests in counting from one to ten, and/or the recognition of colors and/or shapes and/or letters by matching the pins to the markings or holes in the fewest attempts. The toy educational bowling game of the present invention can be produced in various sizes which are appropriate for toddlers, though the preferably sizes have been previously described, and can be played indoors or outdoors. The described bowling game of the present invention can be produced with many unique and original appearances.

The increased entertainment and improvement of reflexes and coordination afforded by the educational toy bowling game of the present invention also results from the preferred adjustable guide walls which facilities knocking down the pins.

With the numbers preferably located in front of the markings on the base additional reinforcement for the recognition of the numbers is provided for they are still visible on the base even after the pins are placed upon the markings opposed to the numbers being place within the markings since with the numbers in the latter location on the base they would not be visible when the pins are placed upon the markings. The lighting system can further provide learning reinforcement by highlighting the numbers, and/or shapes and/or letters and/or colors as preferred.

It can now be understood that the toy educational bowling game of the present invention affords increased entertainment and/or improvement of learning skills including counting and/or recognition of shapes and/or colors and/or letters and/or reflexes and coordination and/or social skills. While different embodiments of the toy educational bowling game has been described in detail, it should be apparent that modifications and variations thereto are possible, all of which fall within the true spirit and scope of the invention.

With respect to the above description then, it is to be realized that the optimum dimensional relationships for the parts of the invention, to include variations in size, materials, shape, form, spacing, components, designs, systems, elements, function and manner of operation, assembly and use, are deemed readily apparent and obvious to one skilled in the art, and all equivalents and equivalent relationships to those described in the specification are intended to be encompassed by the present invention. It should be appreciated that the toy educational bowling game herein described is also suitable for improving concentration and sportsmanship. Furthermore, a variety of pin placement geometries and spacing may be used though the previously described pin set up guide and pin deck provides for the preferred pin placement geometry and spacing. Therefore, the foregoing is considered as illustrative only of the principles of the invention. Further, since numerous modifications and changes will readily occur to those skilled in the art, it is not desired to limit the invention to the exact construction, parts, components, elements, features, designs, spacings, weights, sizes, dimensions, systems, operations and learning scenarios described and/or shown, and/or preferred and/of inferred and accordingly, all suitable modifications and equivalents may be resorted to, falling within the scope of the invention

While the invention has been described in connection with the specific embodiments thereof, it will be understood that it is capable of further modification.

Having described the invention, I claim:

1. A toy educational bowling game for toddlers comprising:
(a) a toy bowling ball,
(b) ten toy bowling pins each marked with an individual and different number from one to ten,
(c) a pin set up guide with ten markings for the placement of said pins and each of said markings has an individual and different number from one to ten arranged in numerical order and in the same numerical alignment as when conventional bowling pins are lined up for the beginning of play of a conventional bowling whereby a toddler can learn to count from one ten by matching said numbered pins in numerical order to said numbered markings on said pin set up guide.

2. The toy educational bowling game for toddlers of claim 1 where said numbers on said pin set up guide are in front of said markings whereby after a toddler matches said pins to said numbered markings, said numbers of said markings are still visible whereby visually reinforcing the learning of the numbers and counting.

3. The toy educational bowling game for toddlers of claim 1 where each of said markings is marked with a different color that matches to one of each of said pins with said same color and number whereby a toddler can learn to count from one to ten and different colors by matching said numbered and colored pins to said same numbered and colored markings in numerical order.

4. The toy educational bowling game for toddlers of claim 1 where each of said markings are indented within said pin set up guide, whereby when a toddler matches and places said pins unto to said markings, said pins can easily remain in place on said markings.

5. The toy educational bowling game for toddlers of claim 1 where each of said markings has a different shape that matches o one of each of said pins marked with said same number and shape whereby a toddler can learn different shapes by matching said pins marked with said number and shape to said markings with said same number and shape.

6. The toy educational bowling game for toddlers of claim 1 where each of said markings has a different letter that matches to one of each of said pins marked with said same number and letter whereby a toddler can learn different letters by matching said pins marked with said number and letter to said markings with said same number and letter.

7. The toy educational bowling game for toddlers of claim 1 which has an audio system with all necessary supporting electronics, which responds with phrases of instructions for the matching of said numbered pins to said numbered markings un numerical order whereby a toddler can be verbally instructed when counting from one to ten by matching said numbered pins in numerical order to said numbered markings.

8. The toy educational bowling game for toddlers of claim 1 which has a lighting system with all necessary supporting electronics which responds to provide visual reinforcement for the learning of numbers and counting from one to ten whereby each of said markings has a light which can show different colors which may include green, yellow and red so each time one of said pins is matched in numerical order to one of said numbered markings, said light of said marking which is so matched may turn on to said color of green and each time one of said numbered pins is placed on said same numbered marking out of numerical order, said yellow light of said marking may be turned on, and each time one of said pins is incorrectly matched to one of said markings, said light of said marking so incorrectly matched may turn on to the color of red or not turn on, and the like whereby a toddler can be visually reinforced to the learning of numbers and counting from one to ten.

9. The toy educational bowling game for toddlers of claim 1,
(a) has an audio system with all necessary supporting electronics, which responds with phrases of instructions and reinforcement for the matching of said numbered pins to said same numbered markings in numerical order,
(b) there is a lighting system with all necessary supporting electronics which responds with visual reinforcement for the matching of said numbered pins to said same numbered markings in numerical order whereby each of said markings has a light which can show different colors which may include green, yellow and red which respond to provide visual reinforcement to learn numbers and to count to count from one to ten, so when each one of said pins is matched in numerical order to one of said numbered markings, said light of said marking which is so matched may turn on to said color of green and each time one of said numbered pins is placed on said same numbered marking out of numerical order, said yellow light of said marking which is so matched may be turned on, and each time one of said pins is incorrectly matched to one of said markings, said light of said marking may turn on to said color of red or not be turn on, and the like, whereby a toddler can be reinforced visually and orally to learn numbers and to count to count from one to ten.

10. The toy educational bowling game for toddlers of claim 1,
(a) where each of said pins is marked with different a color that matches to one of said markings on said pin set up guide which is marked with said same number and color,
(b) there is a lighting system with all necessary supporting electronics whereby each of said markings on said pin set up guide has a light which has two modes, number mode and color mode, which can show different colors which may include green, yellow and red which responds to provide visual reinforcement for the learning of numbers, counting from one to ten and colors and when said lighting system is in number mode each time one of said pins is matched in numerical order to said numbered markings, said light of said marking so matched may turn on to said color of green and each time one of said numbered pins is matched on said same numbered marking out of numerical order, said yellow light of said marking so matched may be turned on and each time one of said pins is incorrectly matched to one of said markings said light of said marking may turn on to said color of red or not turn on, and the like and when said lighting system is in color mode each time one of said pins marked with a particular color is matched to one of said markings with said same color, said light of said marking may turn on to said color of green and each time one of said pins with a particular color is incorrectly matched to one of said markings with a different color, said light of said marking may turn on to said color of red or not turn on, and the like whereby a toddler can be visually reinforced to the learning of numbers, counting from one to ten and colors.

11. The toy educational bowling game for toddlers of claim 1,
(a) where each of said pins is marked with different a color and shape that matches to one of each of said markings on said pin set up guide with said same number, color and shape,
(b) there is a lighting system with all necessary supporting electronics whereby each of said markings on said pin set up guide has a light which has three modes, number mode, color mode and shape mode which can show different colors which may include green, yellow and red which responds to provide visual reinforcement for the learning of numbers, counting from one to ten, colors and shapes and when said lighting system is in number mode, each time one of said pins is matched in numerical order to said numbered markings, said light of said marking so matched may turn on to said color of green and each time one of said numbered pins is matched on said same numbered marking out of numerical order, said yellow light of said marking so matched may be turned on and each time one of said pins is incorrectly matched to one of said markings, said light of said marking may turn on to said color of red or may not turn on, and the like, and when said lighting system is in color mode each time one of said pins marked with a particular color is matched to one of said markings with said same color, said light of said marking may turn on to said color of green and each time one of said pins marked with a particular color is incorrectly matched to one of said markings with a different color, said light of said marking may turn on to said color of red or not turn on, and the like and when said lighting system is in shape mode each time one of said pins marked with a particular shape is matched to one of said markings with said same shape, said light of said marking may turn on to said color of green, and each time one of said pins marked with a particular shape is incorrectly matched to one of said markings with a different shape, said light of said marking may turn on to said color of red, and the like whereby a toddler can be visually reinforced to the learning of numbers, counting from one to ten, shapes and colors.

12. The toy educational bowling game for toddlers of claim 1 whereby
(a) each of said pins is marked with a different color that matches to one of each of said markings on said pin set up guide which have said same number and color,
(b) there is an audio system with all necessary supporting electronics, with two modes, a number mode and a color mode, and when in number mode responds with phrases of instructions and reinforcement for the matching of said numbered pins to said same numbered markings in numerical order, and when in color mode responds with phrases of instructions and reinforcement for the matching of said pins marked with said colors to said markings marked with said same colors, whereby a toddler can be orally reinforced to the learning of numbers and counting from one to ten and colors.

13. The toy educational bowling game for toddlers of claim 1 where each of said markings has a different color and shape that matches to one of each said pins marked with said same number, shape and color whereby a toddler can learn different shapes and colors by matching said pins marked with said same number, shape and color to said markings with said same number, shape and color.

14. The toy educational bowling game for toddlers of claim 1 where each of said markings is marked with a different color that matches to one of each of said pins with said same number and color and each of said markings are indented within said pin set up guide, whereby a toddler can learn to count from one to ten and different colors by matching said numbered and colored pins to said same numbered and colored markings in numerical order, and with said indentations said pins can easily remain in place on said markings.

15. A toy educational bowling game for toddlers, comprising:
(a) A toy bowling ball, a plurality of toy bowling pins which are marked with a separate and different whole number in numerical order starting with the number one,
(b) a pin set up guide thereupon there are a plurality of markings and each of said markings has a separate and different whole number in numerical order starting with the number one and said markings are arranged in the similar numerical alignment as when conventional bowling pins are lined up for the beginning of play of a conventional bowling, whereby a toddler can learn numbers and to count by matching said numbered pins in numerical order to said numbered markings on said pin set up guide.

16. The toy educational bowling game for toddlers of claim 1 where,
(a) each of said markings has a different color and shape that matches to one of each of said pins with said same number, shape and color,
(b) there is an audio system with all necessary supporting electronics, with three modes, a number mode, shape mode and color mode, and when in number mode responds with phrases of instructions and reinforcement for the matching of said numbered pins to said same numbered markings in numerical order and when in color mode responds with phrases of instructions and reinforcement for the matching of said pins marked with said colors to said markings with said same colors and when in shape mode responds with phrases of instructions and reinforcement for the matching of said pins marked with said shapes to said markings with said same shapes whereby a toddler can be orally reinforced to the learning of numbers and counting from one to ten, shapes and colors.

17. The toy educational bowling game for toddlers of claim 1,
(a) where each of said pins is marked with a different color that matches to one of each of said markings on said pin set up guide Which have said same number and color,
(b) there is an audio system with all necessary supporting electronics, with two modes, a number mode and a color mode and when in color mode responds with phrases of instructions and reinforcement for the matching of said numbered pins to said same numbered markings in numerical order and when in color mode responds with phrases of instructions and reinforcement for the matching of said colored pins to said same colored markings,
(c) there is a lighting system with all necessary supporting electronics whereby each of said markings on said pin set up guide has a light which has two modes, number mode and color mode, which can show different colors which may include green, yellow and red which responds to provide visual reinforcement for the learning of numbers, counting from one to ten, and colors and when said lighting system is in number mode each time one of said pins is matched in numerical order to one of said numbered markings, said light of said marking so matched may turn on to said color of green and each time one of said numbered pins is matched on said same numbered marking out of numerical order, said yellow light of said marking so matched may be turned on and each time one of said pins is incorrectly matched to one of said markings, said light of said marking may turn on to said color of red or may not turn on, and the like, and when said lighting system is in color mode each time one of said pins marked with a particular color is matched to one of said markings with said same color, said light of said marking may turn on to said color of green, and each time one of said pins is marked with a particular color is incorrectly matched to one of said markings with a different color, said light of said marking may turn on to said color of red or may not turn on, and the like whereby a toddler can be visually and orally reinforced to the learning of numbers, counting from one to ten and colors.

18. The toy educational bowling game for toddlers of claim 1,
(a) where each of said pins is marked with a different color and shape, that matches to one of each of said markings on said pin set up guide which have said same number, color, and shape,
(b) has an audio system with all necessary supporting electronics, with three modes a number mode, shape mode and color mode and when in number mode responds with phrases of instructions and reinforcement for the matching of said numbered pins to said same numbered markings numerical order, and when in color mode responds with phrases of instructions and reinforcement for the matching of said colored pins to said same colored markings, and when in shape mode responds with phrases of instructions and reinforcement for the matching of said pins marked with particular shapes to said markings with said same shapes,
(c) there is a lighting system with all necessary supporting electronics whereby each of said markings on said pin set up guide has a light which has three modes, number mode, color mode and shape mode which can show different colors which may include green, yellow and red which responds to provide visual reinforcement for the learning of numbers, counting from one to ten, colors and shapes and when said lighting system in number mode each time one of said pins is matched in numerical order to one of said numbered markings, said light of said marking so matched may turn on to said color of green and each time one of said numbered pins is matched on said same numbered marking out of numerical order, said yellow light of said marking so matched may be turned on and each time one of said pins is incorrectly matched to one of said markings, said light of said marking may turn on to said color of red or not turn on, and the like, and when said lighting system is in color mode each time one of said pins marked with a particular color is matched to one of said markings with said same color, said light of said marking may turn on to said color of green, and each time one of said pins marked with a particular color is incorrectly matched to one of said markings with a different color, said light of said marking may turn on to said color of red or may not turn on, and the like and when said lighting system is in shape mode each time one of said pins marked with a particular shape is matched to one of said markings with said same shape, said light of said marking may turn on to said color of green, and each time one of said pins with a particular shape is incorrectly matched to one of said markings with a different shape, said light of said marking may turn on to said color of red or may not turn on, and the like whereby a toddler can be visually and orally reinforced to the learning of numbers, counting from one to ten, shapes and colors.

19. A toy educational bowling game for toddlers comprising:
(a) a toy bowling ball,
(b) ten toy bowling pins and each pin has a lighting apparatus with any necessary supporting electronics which has two modes, a number mode and a color mode, and when in number mode a different and individual number from one to ten is displayed on said pins and when in color mode a different color is displayed on said pins,
(c) a pin set up guide with ten markings arranged in a similar alignment as when conventional bowling pins are lined up for the beginning of play of conventional bowling and each of said markings has a lighting apparatus with any necessary supporting electronics which has two modes, a number mode and a color mode and when in number mode a different and individual number from one to ten is displayed on said markings arranged in numerical order and in the same numerical alignment as when conventional bowling pins d up for the beginning of play of conventional bowling and when in color mode a different color is displayed on said markings which match to one of each of said pins with said same colors and said lighting system can further display additional lights, and the colors of said lights may include green, yellow and red which responds to provide visual reinforcement and when in number mode each time one of said pins is matched in numerical order to one of said numbered markings, said light of said marking so matched may turn on to said color of green and each time one of said numbered pins is placed on said same numbered marking out of numerical order, said yellow light of said marking may turn on and each time one of said numbered pins is incorrectly matched to one of said markings, said light of said marking may turn on to said color of red or may not be turn on, and the like, and when in color mode each time one of said pins with a particular color is matched to said markings with said same color, said light of said markings so matched may turn on to said color of green and each time one of said pins is incorrectly matched to one of said markings, said light of said marking may turn on to said color of red or may not turned on, and the like,
(d) there is an audio system with all necessary supporting electronics, with two modes, a number mode and a color mode and when in number mode responds with phrases of instructions and reinforcement for the matching of said numbered pins to said same numbered markings in numerical order, and when in color mode responds with phrases of instructions and reinforcement for the matching of said pins marked with said colors to said markings marked with said same colors whereby a toddler can be visually and orally reinforced to the learning of numbers and counting from one to ten and colors.

20. A toy educational bowling game for toddlers of claim 19, where each of said ten toy bowling pins has said lighting apparatus with any necessary supporting electronics which has four modes, a shape mode, color mode, number mode and letter mode and when in number mode a different and individual number from one to ten is displayed on each of said pins and when in color mode a different color is displayed on each of said pins and when in shape mode a different shape is displayed on each of said pins, and when in letter mode a different letter is displayed on each of said pins, and said pin set up guide has said lighting apparatus with any necessary supporting electronics which has four modes, a shape mode, color mode, number mode and letter mode and when in number mode a different and individual number from one to ten is displayed on each of said markings arranged in numerical order and in the same numerical alignment as when conventional bowling pins are lined up for the beginning of play of conventional bowling and when in color mode a different color is displayed on each of said markings which match to one of each of said pins with said same color and when in shape mode a different shape is displayed on each of said markings which match to one of each of said pins with said same shape, and when in letter mode a different letter is displayed on each of said markings which match to one of each of said pins with said same letter and said lighting system can further display additional lights, and colors of said lights may include green, yellow and red which responds to provide visual reinforcement and when in number mode each time one of said pins is matched in numerical order to one of said numbered markings, said light of said marking so matched may turn on to said color of green and each time one of said numbered pins is placed on said same numbered marking out of numerical order, said yellow light of said marking may be turned and each time one of said pins is incorrectly matched to one of said markings, said light of said marking may turn on to said color of red or may not be turn on, and the like, and when in shape mode each time one of said pins with a particular shape is matched to one of said markings with said same shape, said light of said marking so matched may turn on to said color of green and each time of said pins is incorrectly matched to one of said markings, said light of said marking with the color of red may be turn on or not turn on, and the like and when in letter mode each time each one of said pins with a particular letter is matched to one of said markings with said same letter, said light of said marking so matched may turn on to said color of green and each time one of said pins is incorrectly matched to one of said markings, said light of said marking with said color of red may be turn on or not turn on, and the like when in color mode each time each one of said pins with a particular color is matched to one of said markings with said same color, said light of said markings so matched may turn on to said color of green and each time one of said pins is incorrectly matched to one of said markings, said light of said marking with said color of red may be turn on or not turn on, and the like, and said audio system with all necessary supporting electronics, has four modes, number mode, color mode, shape mode and letter mode, and when in number mode responds with phrases of instructions and reinforcement for the matching of said numbered pins to said same numbered markings in numerical order, and when in color mode responds with phrases of instructions and reinforcement for the matching of said pins with said colors to said markings with said same colors, and when in shape mode responds with phrases of instructions and reinforcement for the matching of said pins with said shapes to said markings with said same shapes, and when in letter mode, responds with phrases of instructions and reinforcement for the matching of said pins with said letters to said markings with said same letters, and the like whereby a toddler can be visually and orally reinforced to the learning of numbers and counting from one to ten, colors, letters and shapes.
